(19) United States
(12) Patent Application Publication
(10) Pub. No.: US 2005/0261979 A1
(43) Pub. Date: Nov. 24, 2005

(54) Personal digital photo album through an internet site and receiving it as a printed hard copy

(76) Inventor: Rami Cohen, Tel-Aviv (IL)

Correspondence Address: RAMI COHEN, 13 Vri Zvi Grinberg Street, Tel-Aviv, 69379, IL

(21) Appl. No.: 10/849,850

(22) Filed: May 21, 2004

(51) Int. Cl. G06F 17/60

(52) U.S. Cl. 705/26

(57) ABSTRACT

An internet site based on a system allowing the user to place photographs in a virtual digital album and to receive a hard copy from the site operator. The site allows the customer to design the album for himself/herself from various possible choices or according to the customer's unique personal design. This includes the design of the album binding, the pages in the album, the photograph editing style on each page, the number of pages in the album, and additionally a choice of size, colour, graphics and text or graphics printed on the binding, on each one of the album pages and next to each picture in the album. On the site, the customer will have the possibility of sending the virtual album by e-mail to the site's operator, or to someone acting on behalf of the site operator, and to receive a hard copy from the site operator, (or someone acting on behalf of the site operator), of the album designed as stated, and including the said digital pictures designed and selected by the customer.

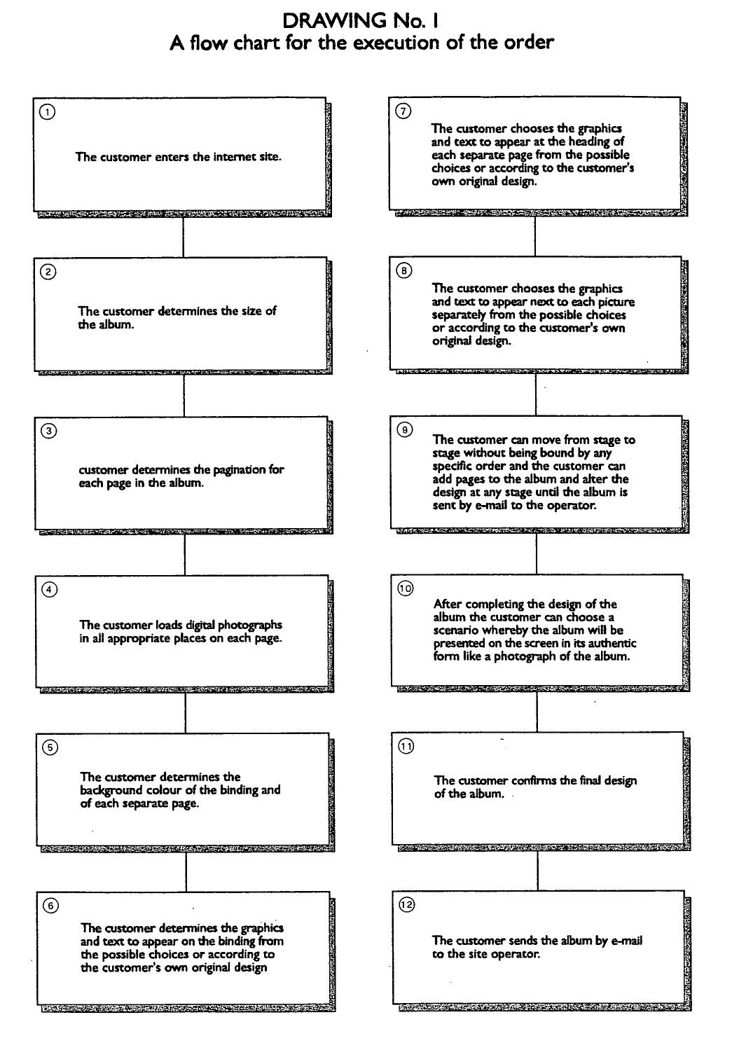

### TECHNICAL FIELD

This invention relates to the field of printing the hard copy of digital photographs after they having been placed in an album designed by the customer from within the options of the customer's personal choices and design. The virtual design of the album is made possible through the internet site of the operator of the invention, which allows the customer to design, by himself/herself, the photo album in which the customer's digital photographs will be placed.

### BACKGROUND ART

Recently, the use by the general public of digital cameras has grown and consequentially many people store files in their computer (or other means of saving the computerised files) in which many digital photographs are stored. Many users print some of the pictures as a hard copy, for various reasons, inter alia, because of the convenience of viewing the photographs and showing them to others or giving them as a gift. Some users print the pictures on home printers, although the printing quality is poor because a high quality printer is very expensive and is to be found with professional printers. At present it is acceptable for a user to load the files he/she is interested in printing onto a diskette, compact disc or other form of saving, which he then delivers to a photo shop where the pictures are printed on hard copy. With the development of the internet, users send their files containing the photographs by email to the photo shop and receive the printed pictures back in hard copy by mail or messenger. At present many internet sites exist where the said service is provided, namely, sending files containing the digital photos by e-mail to the photo shop and receiving the them back from the photo shop in hard copy as individual and separate items.

### BRIEF DESCRIPTION OF THE DRAWINGS

The sole FIGURE, identified as Drawing 1, is a flow diagram describing the steps of the invention.

### DESCRIPTION OF THE PREFERRED EMBODIMENT

The invention is a novel method integrated in the internet site (hereinafter: “the Internet Site”) by which the customer designs the album himself/herself from his/her own digital photographs and he/she receives the album, in hard copy, from the operator of the Internet Site. The design of the album includes, inter alia, the following stages which are also also described in Drawing 1 as follows:

Choosing the Album Binding: The customer chooses the album binding as far as aspects of binding size, the type of material for the binding and the overall design, including colour, graphics and any other text the customer wishes printed on the binding are concerned; These are chosen from the existing options on the Internet Site or according to the customer's unique personal design.

Choosing the Style and Album Pages: The customer chooses the manner in which he wants the pictures to be edited on each page of the album from amongst the options set out in the Internet Site or according to the customer's unique personal design. For example, the customer can determine that there are to be three pictures on each page of the album, one above the next, or, for example, four photos on each page in two rows of two, or in any other form the customer deems appropriate; The customer can determine a different design style for each of the pages in the album.

The Design of the Pages in the Album: The customer chooses the type of material from which the album pages are to be designed as well as choosing the overall design of the album pages including the colour, the graphics and any other text which, in his view, should be printed on each of the pages; All of this is from amongst the existing options on the Internet Site or according to the customer's decision. The customer can determine a different design style for each and every page of the album.

Determining the Number of Pages for the Album: It is the customer who determines the number of pages in the album according to his/her own decision.

Positioning Specific Photographs in the Album: At his own choice, the customer positions the digital photographs in the album in the designated space on each one of the album pages. Wherever a photograph is supposed to be placed in the album, it is possible to position a specific photograph which he customer is interested in having positioned in that specific location.

Adding Captions or Graphics to the Album: The customer can add captions in words or graphics next to each of the photographs he/she places in the album, on each one of the album pages and on the album binding.

Sending to the Internet Site Operator's e-Mail: After the customer has edited the album him/herself according to the above method, he sends the information by e-mail to the Internet Site operator, or to someone acting on behalf of the Internet Site operator, who prints out the album on hard copy according to the customer's design and sends it to the customer, for example, by mail or messenger.

The invention in question allows the customer to personally design the album in which the digital photographs are to be found. This system provides a solution to the problem familiar to the public who are interested in saving their photographs in the form of an album, according to subject matter, in hard copy, and personally designed, all inclusive of graphic text or captions, as stated. In this manner the customer can, for example, edit the album him/herself for birthdays where he/she can, for example, place his/her birthday pictures and add a graphic text or caption alongside the picture, noting, for example, the year the picture was taken, where the picture was photographed, who was present and anything else the customer wishes, and such albums can serve as gifts to others.

1. An Internet Site which based on a method that allows the customer to place digital photographs in a virtual album and to receive a hard copy of the album from the Internet Site operator or from someone acting on behalf of the Internet Site operator.

2. The system described in claim 1 in addition also enables the customer him/herself to design the album from the options available or by his/her unique personal design. This includes the choice of binding sizes.

3. The system described in claim 2, where the customer has the possibility to design the the overall design of the binding concerning aspects of the binding size, its colours, the graphics and the text printed on the binding and this is from among possible choices or by the customer's unique personal design.

4. The system described in claim No. 2, where the customer him/herself can design the album pages from the options or by the customer's unique personal design.

5. The system described in claim 2 where the customer has the possibility to design the overall design of the binding and the pages in the album concerning aspects of the page and/or binding size, its colours, the graphics and the text printed on the binding and/or the pages and this is from possible options or by the customer's unique personal design.

6. The system described in claim No. 5, where the customer has the possibility to design the overall design of the pages in the album concerning aspects of the page size, its colours, the graphics and the text printed on each one of the album pages with the customer having the possibility of determining the manner whereby the pictures will be edited on each one of the pages in the album from the possible options or by the unique personal design of, for example, the customer himself/herself.

7. The system described in claim 6 where the customer has the possibility of adding a verbal or graphic text next to each one of the pictures he/she places in the album in each and every one of the pages in the album and on the album binding.

8. The system described in claim 7 where the customer has the possibility of sending the edited album by e-mail, including all the digital photographs, to the Internet Site operator, or to someone acting on behalf of the Internet Site operator.

9. The system described in claim 9 where the customer has the possibility of sending the edited album by e-mail containing the digital photographs, to the Internet Site operator, or someone acting on behalf of the Internet Site operator and to receive a hard copy of the album from the Internet Site operator or someone acting on behalf of the Internet Site operator.
